(19) United States
(12) Patent Application Publication
(10) Pub. No.: US 2025/0111578 A1
(43) Pub. Date: Apr. 3, 2025

(54) MULTIMODAL PERSONA CONFIGURATION FOR NON-PLAYABLE CHARACTERS

(71) Applicant: ADVANCED MICRO DEVICES, INC., Santa Clara, CA (US)

(72) Inventors: Karthik Mohan Kumar, San Jose, CA (US); Archana Ramalingam, Bellevue, WA (US); Michael Mantor, Orlando, FL (US); Pedro Antonio Pena, Orlando, FL (US)

(21) Appl. No.: 18/898,806

(22) Filed: Sep. 27, 2024

Related U.S. Application Data
(60) Provisional application No. 63/541,516, filed on Sep. 29, 2023.

(51) Int. Cl. G06T 15/00; G06T 15/04; G10L 13/02

(52) U.S. Cl. CPC G06T 15/005; G06T 15/04; G10L 13/02

(57) ABSTRACT

Methods and systems are provided for generating a stylized representation of a non-player character (NPC) in a virtual environment. A multimodal plurality of inputs regarding characteristics of the NPC is received, which is processed to generate visual data representing the NPC's appearance and to generate behavior data representing the NPC's actions. The generated visual data and behavior data are adapted to a selected character model to create an adapted configuration model, which is used to generate rendering information for the NPC.

### BACKGROUND

The present invention relates generally to the field of artificial intelligence (AI) and gaming technology. More specifically, the invention relates to non-playable characters (NPCs) in video games and other digital environments.

Interactive digital environments, such as video games, virtual reality (VR) platforms, and metaverse applications, increasingly rely on non-player characters (NPCs) to enhance user experiences and immersion. NPCs are typically characters in such digital environments that are not controlled by a user. Instead, they are computer-implemented constructs typically designed to display a set of animations and engage in pre-scripted conversations to assist a user in comprehending the storyline or navigating them through a game level. These characters often serve as guides, adversaries, bystanders, or quest-givers in games.

NPCs are often tasked with engaging in complex interactions with users, responding in real time to a wide range of stimuli, and presenting realistic behavior that mirrors the expectations of human-like characters within the environment. Existing approaches to NPC behavior generation, configuration, and control continue to exhibit significant limitations that impact the believability and effectiveness of these interactions.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system designed to implement a persona generation system, in accordance with one or more embodiments.

FIG. 2 depicts an example operational flow for a persona generation system, in accordance with some embodiments.

FIG. 3 illustrates a disentanglement transformation process by a multimodal contextualizer (MMC), which is used to disentangle and process multimodal input data, in accordance with some embodiments.

FIG. 4 illustrates an example operational flow for a texture creator as utilized by a persona generation system, in accordance with some embodiments.

FIG. 5 illustrates an operational flow for a style transfer engine as utilized by a persona generation system, in accordance with some embodiments.

FIG. 6 illustrates an operational flow for a speech engine as utilized by a persona generation system, in accordance with some embodiments.

FIG. 7 illustrates an operational flow for a retargeting engine as utilized by a persona generation system, in accordance with some embodiments.

FIG. 8 illustrates an operational flow for an avatar dressing engine as utilized by a persona generation system, in accordance with some embodiments.

FIG. 9 illustrates a flow diagram of an operational routine for generating a stylized representation of an NPC within a virtual digital environment, in accordance with one or more embodiments.

### DETAILED DESCRIPTION

Past approaches for NPC generation, configuration, and control typically rely on predefined scripts, rule-based logic, or limited AI-driven models that offer only rudimentary capabilities for dynamically adapting to user inputs or context changes within the digital environment. These approaches often struggle to maintain character consistency across different scenarios and modes of interaction, leading to incongruent or unconvincing character behavior that diminishes user experience. Moreover, such systems face difficulties in generating nuanced and contextually appropriate responses that account for a broader situational context, the goals of the interaction, or the character's established persona within the narrative framework of the environment.

Additionally, the need to scale NPC behavior generation to accommodate increasingly complex virtual environments introduces performance bottlenecks and resource constraints, particularly in real-time applications. Addressing these issues while maintaining high fidelity and contextual awareness in NPC interactions poses a significant technical challenge.

Techniques described herein provide improved systems and methods for crafting detailed and customized NPCs in a virtual environment. Such techniques enable users to finely stylize characters, granting them specific appearances, modes of speech, and movements, and even altering their forms, such as based on one or more provided references. Multi-modal inputs and control mechanisms are utilized to accurately translate user preferences into a generated character, addressing the challenges found in current text-to-3D or video models. By utilizing such techniques, NPCs may be newly generated, and/or existing NPC animation sequences and conversations may be modified, in order to align the NPC with the chosen style or persona. In certain embodiments, some or all of the techniques described herein may be implemented via an NPC persona configuration system.

In certain exemplary embodiments described herein, stylized representations of non-player characters (NPCs) are generated for use in a virtual environment by processing multimodal inputs to generate visual and behavior data in accordance with specified NPC characteristics. These techniques involve receiving a plurality of inputs, including persona, animation, and contextual data, to refine both the appearance and actions of an NPC. As used herein, style refers to a character's appearance, behavior, speech, and mannerisms; to stylize an NPC is to modify a style of the NPC to match or emulate a desired reference or persona. In certain embodiments, stylization may involve clothing a character in attire based on a provided reference, such as a specific text description or an image. For example, a reference image may specify a particular outfit, such as a jacket or dress, which is applied to a character model via generated texture maps. As used herein, a character model refers to a digital representation of a character, including its geometric, textural, and anatomical attributes, used within a virtual environment. The model typically includes a mesh (a collection of vertices, edges, and faces that define the shape of a 3D object), and may also include texture maps (images applied to the surface of the mesh to give it color, detail, and texture) and/or rigging data (skeletal structures and skinning weights that allow for realistic movement and deformation).

In some embodiments, stylization also includes modifying the character's speech to align with a reference persona, allowing the character to adopt specific speaking patterns or tones. In a similar vein, the sound of the character's voice can be adjusted to reflect the persona, transforming how the character sounds based on characteristics of the reference input. Stylization may additionally involve transforming a character's visual form entirely to match a given reference. For example, a human character may be transformed into a non-human character, such as a tiger, while preserving key stylistic elements.

In certain embodiments, the system may select a character model based at least in part on the multimodal plurality of inputs, where the NPC's physical structure and appearance are determined in accordance with the persona and behavior aspects provided through the multimodal inputs.

In certain embodiments, techniques described herein enable generating textures such as UV and physically-based rendering (PBR) texture maps, applying neural network-based reverse diffusion refinement processes, and leveraging one or more multimodal contextualizers to effectively process entangled multimodal input data as disambiguated and disentangled modal input data.

In contrast to previous approaches, techniques described herein cover diverse aspects of each NPC, such as may include clothing, speech style, and character movements, among other aspects. Such techniques enable significant character transformations, such as altering a character to resemble a different entity in one or more ways, and thereby providing users a comprehensive tool for character creation and customization. The described techniques provide improved systems and methods for creating, animating, and controlling NPCs that are capable of complex, interactive conversations in video games and other digital environments.

In various embodiments, the described techniques are utilized in a variety of virtual environments and via a range of applications, including game character control, interactive assistants, video teleconferencing, metaverse environments, and entertainment.

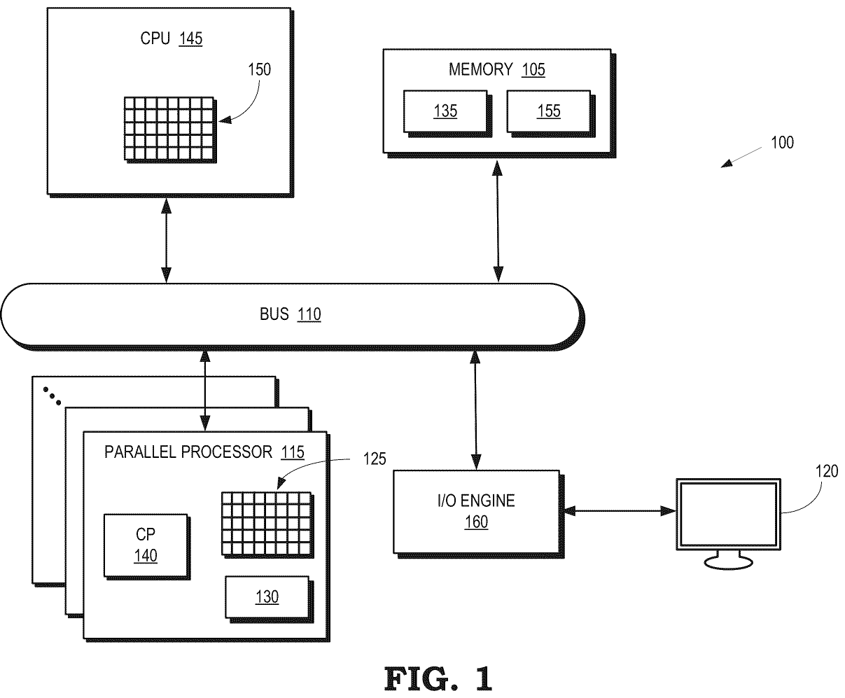

FIG. 1 is a block diagram of a processing system 100 designed to implement NPC persona generation and configuration based on multimodal inputs in accordance with one or more embodiments. The processing system 100 is generally designed to execute sets of instructions or commands to carry out tasks on behalf of an electronic device, such as a desktop computer, laptop computer, server, smartphone, tablet, game console, and the like.

The processing system 100 includes or has access to a memory 105 or other storage component that is implemented using a non-transitory computer readable medium, such as dynamic random access memory (DRAM). The processing system 100 also includes a bus 110 to support communication between entities implemented in the processing system 100, such as the memory 105. In certain embodiments, the processing system 100 includes other buses, bridges, switches, routers, and the like, which are not shown in FIG. 1 in the interest of clarity.

The processing system 100 includes one or more parallel processors 115 that are configured to render images for presentation on a display 120. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 115 can render objects to produce pixel values that are provided to the display 120. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 115 is also used for general-purpose computing. For instance, the parallel processor 115 can be used to implement machine learning algorithms such as one or more implementations of a neural network as described herein. In some cases, operations of multiple parallel processors 115 are coordinated to execute a machine learning algorithm, such as if a single parallel processor 115 does not possess enough processing power to run the machine learning algorithm on its own.

The parallel processor 115 implements multiple processing elements (also referred to as compute units) 125 that are configured to execute instructions concurrently or in parallel. The parallel processor 115 also includes an internal (or on-chip) memory 130 that includes a local data store (LDS), as well as caches, registers, or buffers utilized by the compute units 125. The parallel processor 115 can execute instructions stored in the memory 105 and store information in the memory 105 such as the results of the executed instructions. The parallel processor 115 also includes a command processor 140 that receives task requests and dispatches tasks to one or more of the compute units 125.

The processing system 100 also includes a central processing unit (CPU) 145 that is connected to the bus 110 and communicates with the parallel processor 115 and the memory 105 via the bus 110. The CPU 145 implements multiple processing elements (also referred to as processor cores) 150 that are configured to execute instructions concurrently or in parallel. The CPU 145 can execute instructions such as program code 155 stored in the memory 105 and the CPU 145 can store information in the memory 105 such as the results of the executed instructions.

An input/output (I/O) engine 160 handles input or output operations associated with the display 120, as well as other elements of the processing system 100 such as keyboards, mice, printers, external disks, and the like. The I/O engine 160 is coupled to the bus 110 so that the I/O engine 160 communicates with the memory 105, the parallel processor 115, or the CPU 145.

In operation, the CPU 145 issues commands to the parallel processor 115 to initiate processing of a kernel that represents the program instructions that are executed by the parallel processor 115. Multiple instances of the kernel, referred to herein as threads or work items, are executed concurrently or in parallel using subsets of the compute units 125. In some embodiments, the threads execute according to single-instruction-multiple-data (SIMD) protocols so that each thread executes the same instruction on different data. The threads are collected into workgroups (also termed thread groups) that are executed on different compute units 125. For example, the command processor 140 can receive these commands and schedule tasks for execution on the compute units 125.

In some embodiments, the parallel processor 115 implements a graphics pipeline that includes multiple stages configured for concurrent processing of different primitives in response to a draw call. Stages of the graphics pipeline in the parallel processor 115 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

As used herein, a layer in a neural network is a hardware- or software-implemented construct in a processing system, such as processing system 100. In various embodiments, such a layer may perform one or more operations via processing circuitry of the processing system 100 to serve as a collection or group of interconnected neurons or nodes, arranged in a structure that can be optimized for execution on one or more parallel processors (e.g., parallel processors 115) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data—for example, raw data input into an input layer or the transformed data passed between hidden layers. This transformation process involves the use of an output weight matrix, which is held in memory (e.g., memory 105) and manipulated by the central processing unit (CPU) 145 and/or the parallel processors 115.

In some instances, such layers may be distributed across multiple processing units within a system. For instance, different layers or groups of layers may be executed on different compute units 125 within a single parallel processor 115, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to improve performance of the neural network.

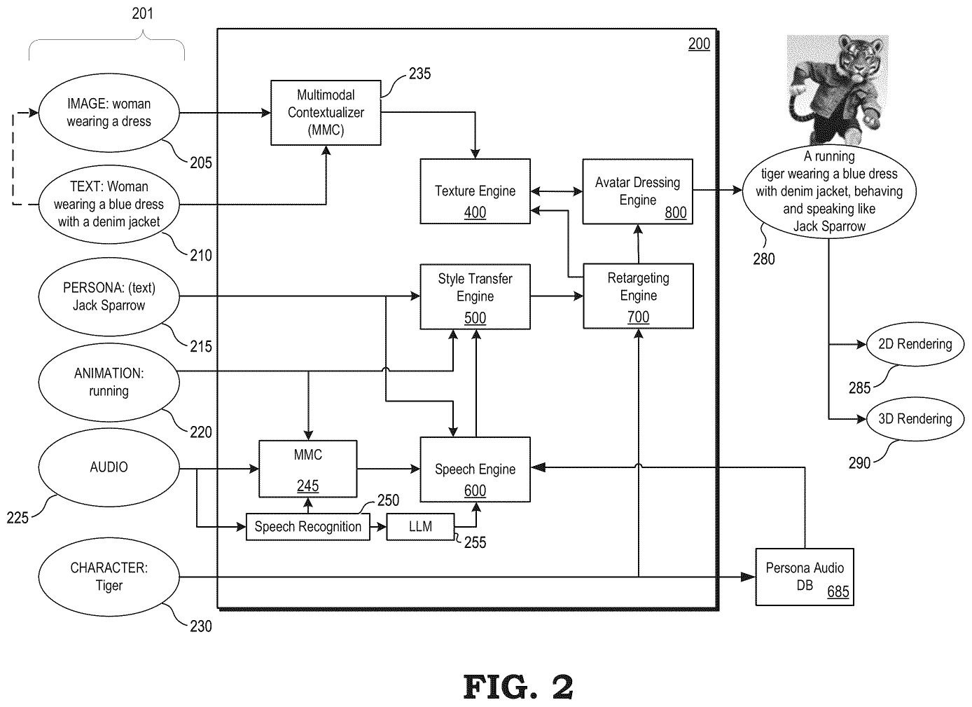

FIG. 2 depicts an example operational flow for a persona generation system 200, in accordance with some embodiments. The persona generation system 200 may be implemented, for example, by a processing system such as the processing system 100 described with respect to FIG. 1. In the depicted embodiment and others, the persona generation system 200 receives a multimodal plurality of inputs regarding multiple characteristics of a non-player character (NPC) for a virtual environment. These inputs are collectively identified herein as input data 201.

For instance, a user may provide textual input 210 describing a “woman wearing a blue dress with a denim jacket,” which can be used in several ways. In some cases, the textual input 210 might be employed to identify a corresponding image input 205—for example, an image of a woman wearing a dress (not necessarily blue) that matches the description. In other scenarios, the textual input 210 and image input 205 may be provided separately, with the image input 205 depicting, for example, a woman wearing a different color dress or different attire altogether. The persona input 215 might specify a character such as “Jack Sparrow,” which will influence the behavior and style attributes of the NPC.

It will be appreciated that in various embodiments and scenarios, the character input 230, animation input 220, and persona input 215 may each be provided via various modalities themselves. For example, the user could either type or speak the “Jack Sparrow” name as the persona input 215, or the user could provide an image of the Jack Sparrow character. Similarly, the character input 230 specifying a “tiger” could be provided as a spoken word, text, or an image of a tiger. In certain embodiments, the character input 230 may be provided as a 3D mesh. The animation input 220 indicating a “running” action could be provided as text, an animation clip, or a 3D animation sequence. The flexibility in accepting input modalities enables the persona generation system 200 to create an accurate and contextually relevant NPC.

In the depicted embodiment, a first subset of the multimodal input data 201 is processed to generate visual data representing an appearance of the NPC (e.g., clothing, facial expressions, and accessories) in accordance with one or more of the multiple characteristics.

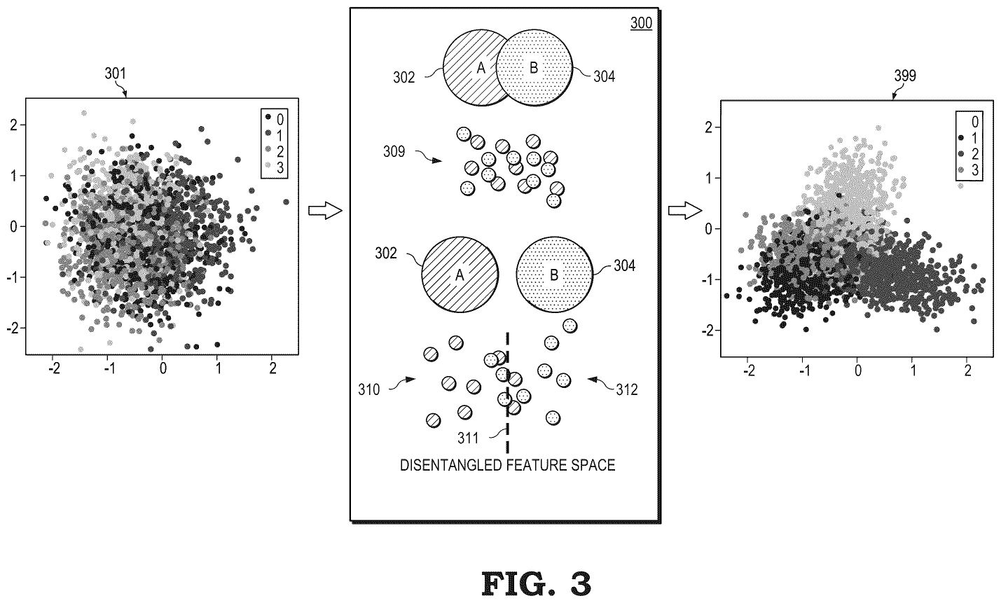

Various portions of the input data 201 are processed by the persona generation system 200 via two distinct multimodal contextualizer (MMC) modules. Generally, and as described in greater detail elsewhere herein with respect to FIG. 3, an MMC is used to integrate and contextualize multimodal input data, such as images, text, audio, and animations, to generate a coherent representation that can be used for further processing by downstream components in the system. The MMC interprets each modality individually and in relation to others, disambiguating and refining the input data to produce outputs that are contextually consistent and relevant for tasks such as texture creation, behavior modeling, and animation synthesis. This process ensures that the various forms of input data are harmonized into a single, unified representation that can be effectively utilized by the system's subsequent processing stages, which in the depicted embodiment include a texture engine 400, speech engine 600, style transfer engine 500, and retargeting engine 700, to generate a realistic and contextually appropriate NPC.

The first MMC 235 processes the image input 205 and textual input 210. The MMC 235 integrates these inputs to generate contextualized representations, mapping the image data to a set of relevant textures or features, and interpreting the text input to extract specific attributes or actions. For example, if the text 210 specifies “a blue dress with a denim jacket,” the MMC 235 may adjust the colors or textures in the image input 205 to match this description.

The output from the MMC 235 is then used by the texture engine 400 to generate textures for the NPC. These textures might include the blue dress with the denim jacket described in the text, adapted to the tiger's body, as specified in the character input 230. The textures are passed to an avatar dressing engine 800, where they are applied to the 3D model of the NPC, effectively ‘dressing’ the character model in the appropriate attire.

Also in the depicted embodiment, a second subset of the multimodal plurality of inputs is processed to generate behavior data representing one or more actions of the NPC in accordance with one or more of the multiple characteristics. These actions can include movements, gestures, and speech, influenced by the NPC's specified persona.

The audio input 225, which in certain scenarios may include audio files or spoken language, is processed by a speech recognition module 250. This module converts the raw audio into transcribed text data, which is then utilized by the LLM 255 to generate contextually relevant moderated text. The LLM 255 processes the transcribed text from the speech recognition module 250 to generate output text that matches the persona input 215, such as by generating and injecting keywords, speech patterns, or phrases aligning with the persona input 215—in the illustrated example, that the character Jack Sparrow might use. This moderated text data is then provided to a large language model (LLM) 255, the output of which, along with the output of MMC 245, is then provided to a speech engine 600 for integrating the audio input 225 with the selected persona, Jack Sparrow, to produce realistic character-specific vocal audio data.

A second MMC 245 processes the animation input 220 and, based on the audio input 225 and the output of a speech recognition module 250 (which also processes the audio input 225), contextualizes these inputs to generate relevant multimodal outputs. The speech recognition module 250 takes the audio input 225 and transcribes it into text, which is further contextualized by the MMC 245. This processed information is then provided to the speech engine 600.

The speech engine 600 generates the NPC's vocal speech data. The speech engine 600 processes inputs from the LLM 255, MMC 245, and persona input 215, providing the resulting vocal speech data to the style transfer module 500.

The style transfer module 500 applies stylistic elements to the NPC based on the persona input 215. For example, a text input specifying “Jack Sparrow” might lead the style transfer module 500 to apply facial expressions, mannerisms, and other behavioral characteristics associated with that persona to a selected target character model. Once the visual and behavioral data are generated, they are adapted to the selected character model to form an adapted configuration model, which is a form of the target character model that has been modified to include those visual and behavioral data. The processing system 200 ensures the adapted configuration model reflects the behaviors and appearance consistent with the multiple aspects provided in the multimodal inputs.

The retargeting engine 700 ensures that NPC-specific behaviors, animations, and other attributes generated by the style transfer engine 500 are appropriately adapted to the selected target character model—in this case, a tiger. This ensures that actions like running, speaking, and other movements are correctly mapped to the tiger's anatomy.

Finally, the completed and retargeted NPC is rendered for the virtual environment. The NPC output 280 is a running tiger wearing a blue dress with a denim jacket, behaving and speaking like Jack Sparrow. The system then generates rendering information for the NPC based on the adapted configuration model, ensuring that the NPC's appearance and behavior are visually coherent and rendered accurately in the virtual environment. For example, in the depicted embodiment, the output can be rendered in either or both of a 2D rendering form 285 or 3D rendering form 290, depending on the virtual environment in which the configured NPC is to appear.

FIG. 3 illustrates a disentanglement transformation process within a multimodal contextualizer (MMC) 300, which is used to disentangle and process multimodal input data into meaningful representations in accordance with some embodiments. Implementations of the MMC 300 are used, for example, as the respective MMCs 235 and 245 in the operational flow described with respect to FIG. 2. Additional details regarding operations of a multimodal contextualizer are described in U.S. application Ser. No. 18/749,032, which is hereby incorporated in its entirety.

As used herein, contextualized data refers to data or input that has been processed and interpreted in relation to other relevant inputs or surrounding information, such that the resulting output is coherent, consistent, and aligned with the desired attributes or functionalities of the system. Contextualization involves disambiguating the input, integrating it with other forms of data, and refining it to ensure that the final output is meaningful and applicable in the intended context, such as within a virtual environment or an NPC generation system.

Starting with the leftmost section of FIG. 3, a diagram 301 represents the initial state of the input data. In this state, various features from different modalities (such as images, text, and audio) are “entangled,” meaning that the information is interwoven, making it difficult to distinguish or separate the unique characteristics and contributions of each modality. The entangled feature space depicted by the dense clustering of data points in the diagram 301 represents the challenge of directly using this data for downstream tasks due to its complexity and interdependency.

As used herein, a feature space refers to a multidimensional space in which each dimension represents a distinct feature or attribute extracted from data. In this space, individual data points are represented by vectors, with each vector's coordinates corresponding to the values of the features for a given input. The corresponding feature space allows for the visualization and analysis of relationships and patterns within the data, facilitating tasks such as classification, clustering, and transformation. In the context of FIG. 3, the circles labeled A and B represent distinct input modalities, such as image and text, and the data points within these circles illustrate how features from these modalities are distributed within their respective feature spaces. The process depicted in FIG. 3 shows the disentanglement of these feature spaces, where the overlapping and entangled features of the modalities are separated into distinct, disentangled feature spaces that better capture the unique characteristics of each modality.

The central section 300 illustrates the process of disentanglement by which the MMC 300 separates the initially entangled feature space 309 into distinct clusters 310 and 312, which represent the separated, modality-specific latent spaces. This disentanglement process allows the MMC 300 to map raw multimodal data (e.g., multimodal input data 201 of FIG. 2, or a subset thereof) into a structured form in which the individual characteristics of each modality can be independently analyzed and utilized. The dashed line 311 represents the boundary between the disentangled feature spaces 310 and 312, illustrating the separation between different modalities. By disentangling those modalities, ensuring that they do not interfere with each other while still allowing for efficient cross-modal translation. For example, in this disentangled space, modality-specific operations (like translation or transformation from modality A to modality B) can be efficiently executed without losing the distinct characteristics of each modality.

The diagram 399 shows the resulting feature space after processing the disentangled features. Here, data points are more spread out and organized compared to the initial entangled state in diagram 301. This organization allows for easier interpretation and use of the data in downstream tasks.

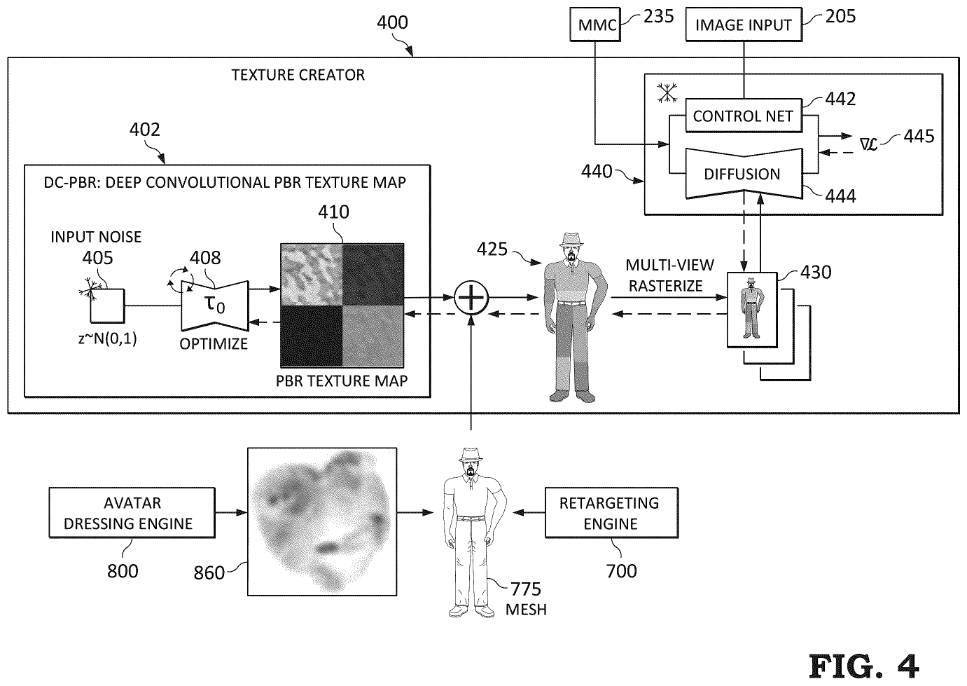

FIG. 4 illustrates an example operational flow for a texture creator 400 as utilized by the persona generation system 200, in accordance with some embodiments. In the depicted embodiment, the texture creator 400 is responsible for generating one or more texture maps to be applied to a 3D mesh 775 of an NPC. In the depicted embodiment, the texture creator 400 integrates image input data 205 with one or more machine learning models, including a text-to-image diffusion model 440, to generate realistic and contextually appropriate textures for the NPC in a virtual environment.

In the depicted embodiment, the process begins receiving the image input 205, as well as contextualized input from the multimodal contextualizer (MMC) 235. The contextualized image input is provided to a text-to-image diffusion model 440, which comprises a control network 442 coupled to a diffusion neural network 444. The control network 442 applies control constraints to guide the diffusion neural network 444 as it generates the initial texture maps for the NPC. This process is further optimized by a similarity loss 445, which ensures that the generated textures maintain structural consistency with the input data, preserving relevant features from the image input. In the depicted embodiment, the text-to-image diffusion model 440 operates using frozen or static weights, as indicated by the adjacent snowflake. These frozen weights ensure that the diffusion model 440 maintains consistency and stability when generating textures based on the image input 205. By utilizing pre-trained weights, the diffusion model 440 is able to preserve the learned relationships and patterns in the data, such as the interaction between colors, lighting, and materials, while applying the desired stylistic modifications from the multimodal input data. This prevents unwanted distortions or alterations to the image during the diffusion process, ensuring that the generated textures retain high-quality features while reflecting the intended stylistic elements.

In parallel, the system employs a Deep Convolutional PBR (Physically-Based Rendering) texture map model 402, which generates various texture channels. In the depicted embodiment, the texture map model 402 generates diffuse maps, normals maps, roughness maps, and metallic maps for subsequent processing stages. It will be appreciated that in various embodiments and scenarios, a variety of other maps may be generated using substantially similar techniques. For example, potential other maps from the texture creator 400 and the texture map model 402 may include, as non-limiting examples: opacity/alpha maps for use in defining transparent or semi-transparent parts of one or more textures (e.g., for NPC clothing or accessories); specular maps, for use in defining reflective properties of one or more surfaces; height/displacement maps, for use in creating the illusion of depth on one or more surfaces; etc., including diffuse, roughness, metallic, and normal maps.

In the depicted embodiment, input noise 405 serves as a seed for texture generation. The input noise 405 is processed by a deep convolutional model 408, which iteratively optimizes a collection of texture maps 410 for rendering in a virtual environment. The output includes texture components like roughness and metallic properties that contribute to realistic material representation. The texture maps 410 generated by the texture map model 402 are combined through an additive process, resulting in a fully rendered, textured representation 425 of the NPC. The texture maps 410 are applied to the 3D mesh 775, which provides the visual framework for the NPC. In various embodiments and scenarios, the 3D mesh 775 may be derived from a base NPC model or generated via the retargeting engine 700, described in greater detail elsewhere herein.

Once the texture maps 410 are applied, a multi-view rasterizer 430 processes the textured model 425 to generate multiple rasterized images of the NPC from different angles, ensuring the textures are accurately represented across all perspectives in the virtual environment. These rasterized images are fed into a pre-trained diffusion model 440, which incorporates output from MMC 235 describing the textured object. The diffusion model 440, via a control network 442 coupled to a diffusion neural network 444, assesses via a similarity loss 445 whether the image input 205 aligns closely with the text description provided. The similarity loss 445 enables the texture creator 400 to evaluate the consistency between the generated images and the output from MMC 235, guiding the texture map model 402 iteratively to adjust the texture mappings. This iterative process continues until the similarity loss 445 converges to a minimal value.

Thus, the texture creator 400 integrates machine learning-based diffusion techniques and deep convolutional rendering models to produce highly realistic textures that can be adapted to different character models, enabling a visually coherent and contextually accurate NPC in the virtual environment.

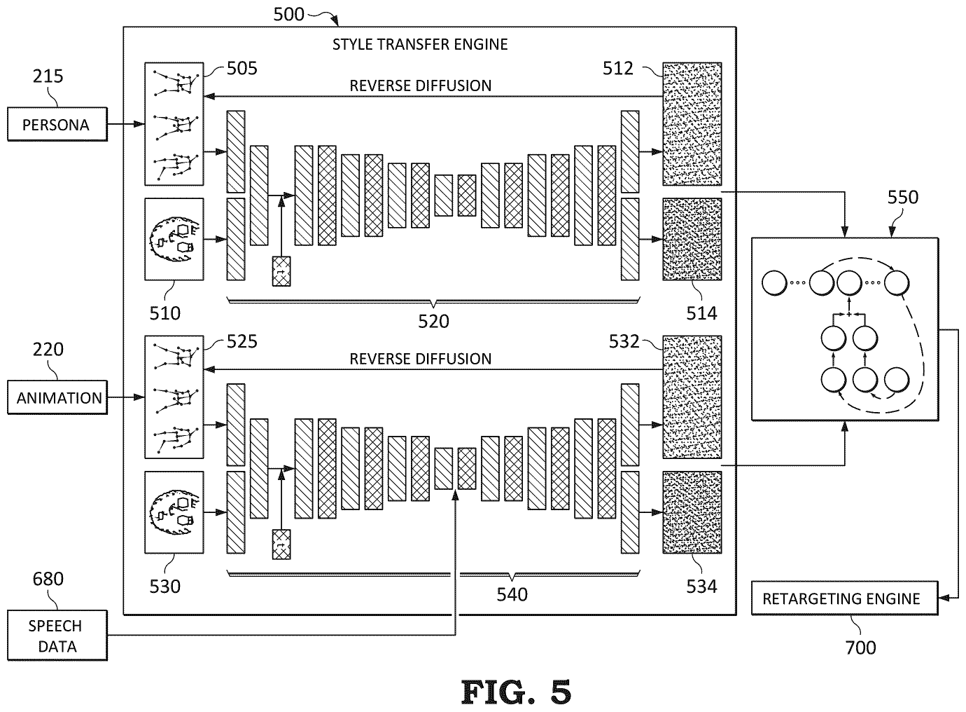

FIG. 5 illustrates an operational flow for a style transfer engine 500 as utilized by the persona generation system 200, in accordance with some embodiments. In certain embodiments, stylization affects the character's movement and facial expressions, adjusting the manner in which the character moves its body and face to align with one or more reference inputs, such as replicating the mannerisms of a specific individual or persona.

In the depicted embodiment, the style transfer engine 500 processes persona input 215 and animation input 220 to modify the NPC's behavior and visual characteristics in a manner consistent with the desired persona and actions. The style transfer engine 500 integrates these inputs through reverse diffusion neural networks using noise (such as gaussian noise) to refine the NPC's joint trajectories and facial expressions, ensuring stylistic consistency across various aspects of the character.

In certain embodiments, the animation input 220 comprises a source animation sequence (x) and a style animation sequence (y). Both sequences are processed through reverse diffusion processing stage 520 to produce respective diffusion latents: diffusion latent x for the source animation sequence and diffusion latent y for the style animation sequence. The source animation sequence (x) starts from the provided animation input 220 and is subject to added noise, while the style animation sequence (y) starts from Gaussian noise (such as gaussian noise blocks 512 and 514) and is guided by the persona input 215. To harmonize the two sequences, a low-pass filter F is applied (such as via a harmonization processing stage 550, described below), allowing the system to blend the high-frequency details of the source animation sequence with the low-frequency details of the style animation sequence. In some embodiments, such blending is performed using the equation xt=F(yt)+xt−F(xt), where the high-frequency motion details of the source animation sequence are combined with the low-frequency stylistic elements of the style animation sequence. This motion harmonization effectively changes the content of the source animation sequence to reflect the style and mannerisms of the persona associated with the style animation sequence, resulting in stylistically modified behavior data that aligns with the reference persona.

In the depicted embodiment, the persona input 215 is provided to the reverse diffusion processing stage 520, which refines and modifies it using gaussian noise blocks 512 and 514 to generate joint trajectory data 505 and facial vertex displacement data 510. The joint trajectory data defines the movement of the character's joints, while the facial vertex displacement data determines how the character's facial vertices are adjusted to reflect expressive elements of the persona. For example, when generating an NPC based on the Jack Sparrow persona, the reverse diffusion stage processes the persona input to generate characteristic gestures, facial expressions, and body language that align with the persona's characteristics.

In a similar manner, the animation input 220 is provided to the reverse diffusion processing stage 540. This input is refined through the neural network using gaussian noise blocks 532 and 534 to generate joint trajectory data 525 and facial vertex displacement data 530, which correspond to the specific movements and expressions indicated by the animation input. For example, if the animation input specifies a running action, the reverse diffusion processing stage 540 processes the input to ensure that the NPC's body movements and facial dynamics reflect that action while still aligning with the indicated persona.

In addition to the persona input 215, speech data 680, which is generated by the speech engine 600 and represents the NPC's dialog and voice characteristics, is provided to the reverse diffusion processing stage 540. This stage processes the speech data alongside the animation input 220, refining the NPC's joint trajectory data 525 and facial vertex displacement data 530. By incorporating speech data directly into the reverse diffusion processing stage, the system ensures that the NPC's physical movements, facial expressions, and speech are all synchronized. This integration of speech into the movement data allows for cohesive NPC behavior, such that the character's dialog and voice patterns are reflected in their body language and facial dynamics.

Each reverse diffusion stage operates iteratively to refine the input data, gradually improving the NPC's joint and facial trajectories based on the inputs. The refined data from the reverse diffusion processing stages 520, 540 are then passed to the harmonization processing stage 550, which further integrates the modified behavior and visual characteristics.

The harmonization processing stage 550 aligns the high-pass (HP) and low-pass (LP) components of the data to ensure stylistic coherence between the NPC's behavior, movement, and appearance. For example, the harmonization process ensures that the running movement derived from the animation input is consistent with the character's facial expressions and body language, which were derived from the persona input.

Once the harmonization processing stage 550 is complete, the modified data is output to the retargeting engine 700, which adapts the stylistically adjusted behavior and visual characteristics to the NPC's target character model. This ensures that the NPC's body movements, facial expressions, and overall behavior are consistently aligned with both the persona and the character model in the virtual environment.

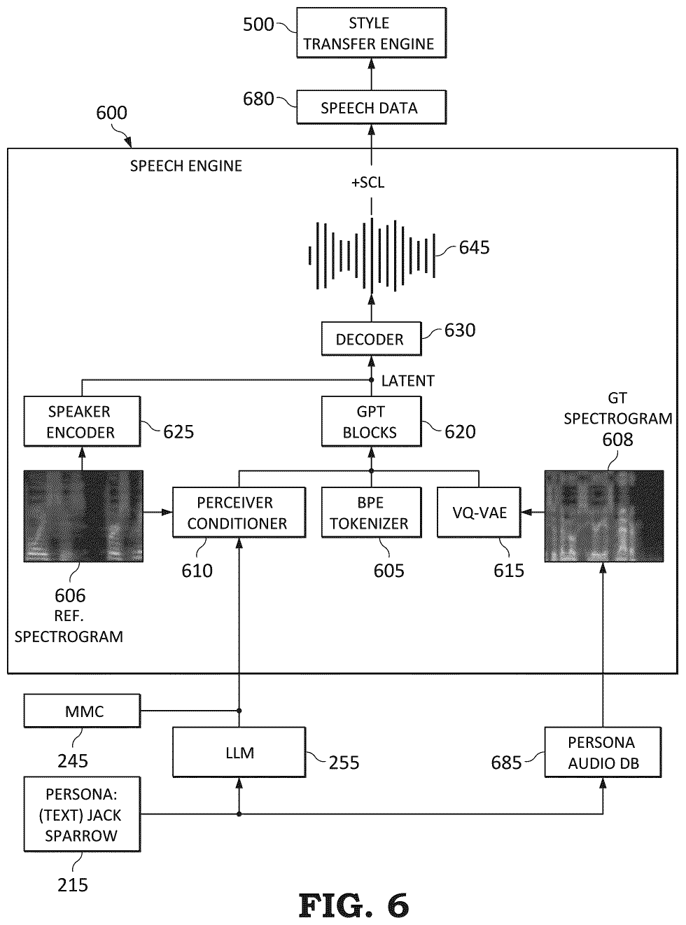

FIG. 6 illustrates an operational flow for a speech engine 600 as utilized by the persona generation system 200, in accordance with some embodiments. Generally, the speech engine 600 processes a multimodal plurality of inputs (e.g., multimodal input data 201 of FIG. 2, or a subset thereof) to generate speech data in accordance with one or more of multiple NPC characteristics specified by those multimodal inputs. In the depicted embodiment, the speech engine 600 is responsible for generating NPC-specific vocal audio based on the persona input 215, multimodal contextualized inputs from the multimodal contextualizer (MMC) 245, and persona-moderated text from the large language model (LLM) 255. In various embodiments, the speech engine 600 integrates multiple subsystems for generating contextually appropriate actions, mannerisms, and vocal characteristics.

In the depicted embodiment, the speech engine 600 receives multimodal inputs from the multimodal contextualizer (MMC) 245 and the large language model (LLM) 255. The MMC 245 provides contextualized multimodal data that includes information from audio, textual, and animation inputs, disambiguated for downstream processing. The output from the MMC 245 MMC helps in aligning the text, audio and animation to help generate more nuanced action-driven audio features. Meanwhile, the LLM 255 consumes the text provided by speech recognition module 250 and generates persona-moderated text that reflects the NPC's dialogue and speech patterns.

The reference spectrogram 606 and ground truth (GT) spectrogram 608 represent key audio features. The reference spectrogram 606 corresponds to a spectrogram that is used as input for generating or moderating speech behaviors based on the NPC's persona. This spectrogram acts as a baseline to help align the generated behavior with the specific characteristics of the NPC's vocal performance, enabling the speech engine 600 to adapt audio input 225 to various persona-specific audio components (e.g., pitch, tone and amplitude) and augments the speech as moderated by LLM 255 to include persona-specific vocabulary. The GT spectrogram 608 is used as a comparison point during the generation of speech data, ensuring that the output aligns with expected vocal characteristics.

The persona audio database 685 stores pre-existing audio data that is persona-specific, which can be used for refining or generating the final speech output for the NPC. This database includes pre-recorded audio samples or synthesized outputs that match and/or simulate the vocal style of specific personas, serving as reference material for the speech engine 600 during speech synthesis.

In the depicted embodiment, the outputs from the MMC 245 and LLM 255, along with the reference and GT spectrograms, feed into a perceiver conditioner 610, a Byte Pair Encoding (BPE) tokenizer 605, and a vector-quantized variational autoencoder (VQ-VAE) 615.

The perceiver conditioner 610 is responsible for processing multimodal inputs, which in the depicted embodiment include moderated text from LLM 255 (which, as described elsewhere herein, is based on the persona input 215) and the contextualized data from the MMC 245, such as to condition the input data for subsequent processing by Generative Pretrained Transformer (GPT) blocks 620 (as discussed below). The perceiver conditioner 610 harmonizes the multimodal inputs, ensuring that various aspects of the NPC's behavior, including speech patterns, body language, and contextual nuances, are properly conditioned for subsequent processing.

The BPE tokenizer 605 tokenizes the persona-moderated textual input from the LLM 255. It breaks down the textual input into subword units or byte pairs, which enables more efficient processing of both common and rare words. This method ensures that the LLM-generated text is accurately represented as input to the speech engine 600.

As used herein, a variational autoencoder (VAE) is a generative model used to learn latent representations of input data. Unlike traditional autoencoders, which directly compress input data into a latent space and decompress it back to its original form, a VAE imposes a probabilistic framework on this process. Specifically, a vector-quantized VAE learns to encode input data into a distribution in a discrete latent space, allowing for better generalization and enabling the VAE to generate new data points by sampling from this learned distribution. The VQ-VAE 615 processes the GT spectrogram for encoding and decoding speech data in a manner that captures the high-level features necessary for generating contextually appropriate speech, and generates latent vectors representing key speech features for processing by the GPT blocks 620, as described below.

Once the data is processed by the perceiver conditioner 610, BPE tokenizer 605, and VQ-VAE 615, it is fed into the GPT blocks 620, which are a series of decoder- and transformer-based layers that handle the processing and generation of the NPC's behavior data. The GPT blocks 620 take the conditioned inputs and latent representations, and predict sequential behaviors (speech patterns) for the NPC, transforming the raw input data into coherent dialogue that fits the NPC's persona and context within the virtual environment.

The GPT blocks 620 generate latent text representations that are provided to a decoder 630 to output audio waveform 645. In certain embodiments, the decoder 630 is based on one or more vocoders (e.g., a HiFi-GAN vocoder) to output the audio waveform 645. The decoder 630 is conditioned by speaker embeddings from the reference spectrogram 606 via a speaker encoder 625. In the depicted embodiment, in order to improve speaker similarity, Speaker Consistency Loss (SCL) is also added. As used herein, speaker consistency loss refers to a measure of the discrepancy between the expected and generated acoustic features of a speaker's voice in a synthesized audio output. This metric is used to ensure that the speech data 680 remains consistent with the characteristics of the target speaker's voice across tone, pitch, and other vocal attributes.

The speech engine 600 processes the latent speaker representations through a speaker encoder 625 and a discriminator 640. The speaker encoder 625 ensures that the generated speech aligns with the NPC's persona, creating a speaker profile that matches the persona input 215. The discriminator 640 further refines the speech patterns, ensuring that the output is consistent with the intended persona characteristics. The outputs from the speaker encoder 625 and discriminator 640 are then passed to a second speaker encoder 650.

In the depicted embodiment, speaker encoder 650 generates speech data 680 based on the audio waveform 645, and the speech data 680 is provided to the style transfer engine 500, in which (as described in greater detail elsewhere herein) the NPC's behavior data is modified based on one or more NPC characteristics (such as those associated with the persona input 215, as one non-limiting example).

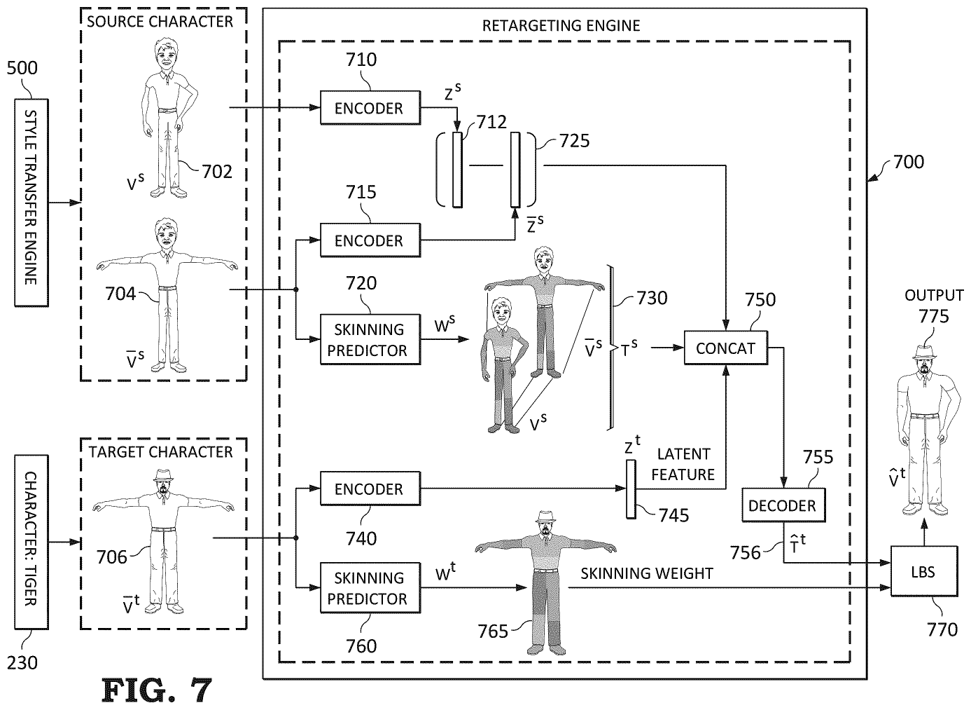

FIG. 7 illustrates an operational flow for a retargeting engine 700 as utilized by the persona generation system 200, in accordance with some embodiments. As used herein, the source character refers to an original character from which attributes such as movement, behavior, or appearance are derived for adaptation, while the target character is a character onto which these attributes are transposed and adapted to produce a new, stylized representation of the target character within a virtual environment. The retargeting engine 700 first projects both a target pose 702 (the desired pose for the NPC character) and canonical pose 704 (a reference T-pose typically used in graphical character modeling) of the source character-represented by different source character vectors—into a latent space Z using respective transformer encoders 710 and 715. The retargeting engine 700 then computes the difference Zd between the latent representations of the canonical and target poses. This difference informs the transformation process between the source character's various poses.

Next, the retargeting engine 700 projects the canonical pose 704 of the source character through a skinning predictor network 720 to predict skinning weights W for K deformation parts of the character model. These skinning weights allow the system to compute the transformation of each deformation part Ts 730 between pairs of source meshes. Concurrently, the target character's canonical pose 706 is projected into its own latent space, generating feature vector Zt 745, and the skinning predictor network 760 computes the target character's skinning weights Wt 765. The system combines Zt 745, Ts 730, and Zd 725 as inputs to a transformer decoder 755, which predicts the transformation Tt 756 for the target character. With the predicted skinning weights Wt 765 and transformation Tt 756, the retargeting engine 700 deforms the target character 706 into the target pose 775 via linear blend skinning (LBS) 770, enabling the adapting of visual and behavior data to be reflected on the target character model in the virtual environment.

In the depicted embodiment, the retargeting engine 700 adapts the characteristics of a source character to a target character model, ensuring that the generated behavior and visual data correspond correctly to the target character. The inputs to the retargeting engine 700 include outputs from the style transfer engine 500 and the character input 230.

Continuing the example discussed with respect to FIG. 2, the source character would be Jack Sparrow, and the selected target character model would be a tiger. The source character's movements, mannerisms, and characteristics (as specified by the persona input 215) are retargeted to the target character (the tiger), so that the tiger's movements reflect the behaviors and style associated with Jack Sparrow. The style transfer engine 500 provides data that influences the adaptation of the source character's style, which includes source character characteristics such as behavior and visual aspects.

To facilitate transfer of the source character's animations and behaviors to the target character model by the retargeting engine 700, two source character vectors 702 and 704 are utilized to represent Jack Sparrow, while a target character vector 706 represents the selected tiger character model in a T-pose position (a canonical reference pose typically used in graphical character modeling). The T-pose position standardizes the character's posture, simplifying the process of mapping poses from the source character to the target character.

The source character vector 702, representing the source character in one of various poses, is processed by an encoder 710 to generate a corresponding latent feature vector 712. This latent feature vector encodes the source character's pose and vertex and/or geometry structure. The source character vector 704, which represents the source character in the same T-pose as that of the target character, is processed by another encoder 715. This encoding generates another latent feature vector 725, which corresponds to the source character's T-pose. The delta vector between latent feature vector 712 and latent feature vector 725 represents a geometric difference vector between the source character in the pose indicated within source character vector 702 and the T-pose position indicated by source character vector 704, facilitating alignment with the target character.

The source character vector 704 is also processed by a skinning predictor 720, which predicts a skinning weights vector 730 for the target character (Ws). The skinning weights in the skinning weights vector 730 determine how the target character's vertices and/or geometry deform during animation, ensuring that the source character's movements and poses are accurately adapted to the target character.

Separately, the target character vector 706 is processed by an encoder 740 to encode the target character's geometric structure and transformations, generating a corresponding latent feature vector 745. The target character vector 706 is also processed by a separate skinning predictor 760, which predicts the skinning weights vector 765 for the target character (Wt). These skinning weights determine how the target character's geometry deforms during animation, ensuring that the source character's movements and poses are accurately adapted to the target character.

The latent feature vector 745 from the target character, the delta vector comprising the delta between latent feature vector 712 and latent feature vector 725, and the skinning weights vector 730 for the target character are all combined via a concatenation block 750, merging their respective sets of data. The resulting merged data (not separately shown) is processed by decoder 755, which responsively generates a transformed character dataset 756 of pose and motion data for the target character. The character dataset 756 aligns the pose, behavior, and appearance of the source character with the target character's physical attributes and geometric structure.

The character dataset 756 is then passed to a linear blend skinning (LBS) module 770, which combines the latent features represented thereby with the skinning weights vector 765 from the target character to produce a final animated representation 775 of the target character. This animated representation 775 represents the fully animated target character, with all of the source character's adapted behavior and appearance characteristics transferred onto the target character model.

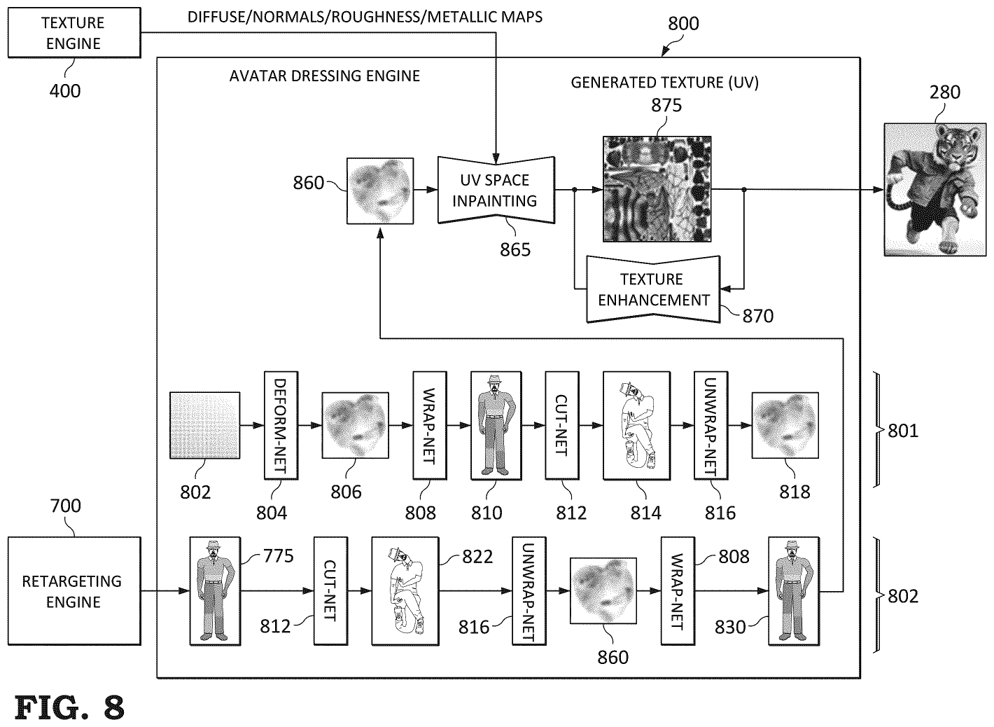

FIG. 8 illustrates an operational flow for an avatar dressing engine 800 as utilized by the persona generation system 200, in accordance with some embodiments. The avatar dressing engine 800 receives inputs from the texture engine 400 and the retargeting engine 700, and is responsible for generating and applying textures to the NPC for display within a virtual environment. Multiple transformative neural network processing stages within the avatar dressing engine 800 apply a series of transformations to the input character model, projecting its 3D geometry to a 2D plane and modifying its texture mapping and visual appearance through the application of neural network-based algorithms. These transformative neural network processing stages may be fully developed neural networks or comparatively simple multilayer perceptrons, iteratively refining the character's form and texture to align with the multimodal input data 201 and produce a realistic, visually coherent NPC suitable for rendering.

The process begins with the retargeting engine 700 providing the character representation 775, which represents the target character with its behavior and pose aligned with the source character's behavior and characteristics. This representation 775 is then processed through a sequence of stages within the avatar dressing engine 800 to adapt and finalize the textures for the NPC.

In a first series of neural network operations 801, the avatar dressing engine 800 utilizes a uniformly sampled 2D lattice grid 802 containing preliminary image data related to the textures or visual features of the target character. This lattice grid 802 is fed into a deform-net processing stage 804, which maps 2D lattice points to UV coordinates, creating a deformed texture map 806 based on the target character's mesh and skeletal configuration. This map ensures correct alignment of the texture with the target character's specific 3D surface.

Subsequently, the deformed texture map 806 is processed by a wrap-net 808, reconstructing a 3D model of the character by wrapping the texture map around the character's 3D mesh to generate an intermediate representation 810. This stage ensures correct application of the texture across the model's surface.

Following this, a cut-net 812 strategically creates “cuts” or seams in the texture mapping, producing a developable surface manifold 814. This step groups together texture regions with similar visual properties or adjacent regions of the model, reducing distortions in the applied texture.

The developable surface manifold 814 is then unwrapped by an unwrap-net 816, projecting the texture from the 3D model back into a 2D plane to refine the texture map. This refined texture map, referred to as the unwrapped texture data 818, incorporates adjustments from the preceding stages, accurately reflecting the target character's geometry and appearance.

In a second series of neural network operations 802, the neural networks trained in the first series of operations 801 begin with the input character representation 775, which is unwrapped by the cut-net 812 to generate a developable surface manifold 822. The unwrap-net 816 (previously trained in the first stage) unwraps the developable surface manifold 822 to generate a base UV texture map 860. The base UV texture map 860 is then wrapped around the 3D mesh to generate a final wrapped character representation 830 that is fully textured but without color data.

The base UV texture map 860 is enhanced via a UV space inpainting stage 865, which colorizes the UV coordinates appropriately. The UV space inpainting stage 865 is complemented by a texture enhancement module 870, which refines the inpainted texture data by reducing artifacts and smoothing seams, enhancing the overall texture quality. The resulting full UV texture map 875 integrates both the inpainted base texture and the enhancements from the texture enhancement module, applying this comprehensive texture to the target character representation 775.

The final NPC output 280, exemplified as a tiger wearing a denim jacket, is the culmination of this detailed texturing process conducted by the avatar dressing engine 800. The full UV texture map 875, having undergone several iterative refinements and enhancements, ensures the NPC is displayed in the virtual environment with a visually coherent and realistically textured appearance, aligned with the multimodal inputs provided to the persona generation system 200.

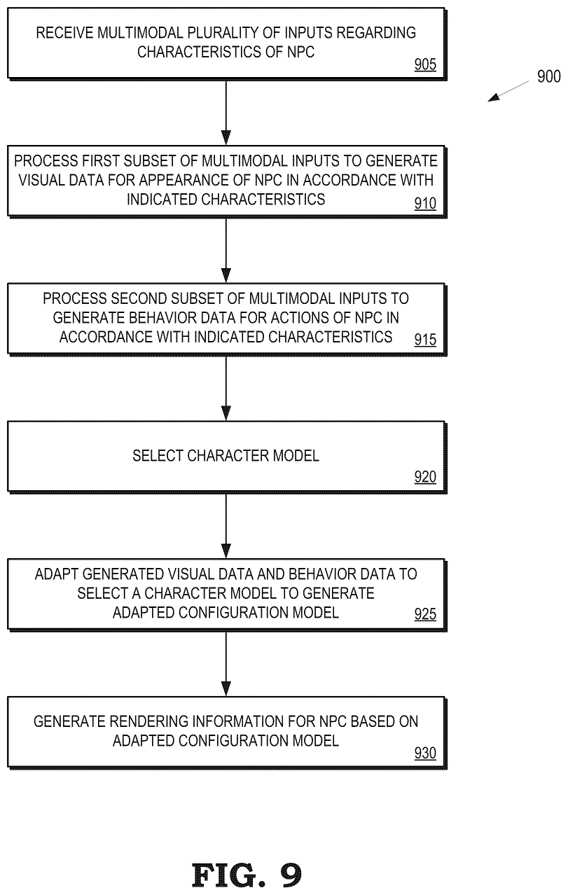

FIG. 9 illustrates a flow diagram of an operational routine 900 for generating a stylized representation of an NPC within a virtual digital environment, in accordance with one or more embodiments. The operational routine 900 may be performed, for example, by one or more hardware processors executing an embodiment of a persona generation system (e.g., persona generation system 200 of FIG. 2).

At block 905, the routine begins by receiving a multimodal plurality of inputs regarding characteristics of the NPC. These multimodal inputs may include text, images, audio, animation sequences, or other forms of input data that define multiple aspects of the NPC. For example, the inputs may describe the NPC's visual appearance, behavior, or persona characteristics (e.g., a “Jack Sparrow” persona and “tiger” character model). The multimodal inputs provide comprehensive data for determining both the appearance and behavior of the NPC.

At block 910, the routine processes a first subset of the multimodal plurality of inputs to generate visual data for the appearance of the NPC in accordance with the indicated characteristics. This visual data may include texture maps, 3D models, or other graphical representations based on the input modalities. For instance, the system may generate textures and models for a tiger character wearing a jacket and styled with the mannerisms of “Jack Sparrow.” The system derives the visual appearance of the NPC by synthesizing multiple forms of input data to create a coherent visual representation.

At block 915, the routine processes a second subset of the multimodal plurality of inputs to generate behavior data representing one or more actions of the NPC in accordance with the indicated characteristics. For example, this step may include generating specific animations or behavioral characteristics such as body language, facial expressions, personalized conversations, or walking/running styles that correspond to the persona input (e.g., Jack Sparrow) and the character model (e.g., tiger). The behavior data defines how the NPC will act or move within the virtual environment, reflecting its persona and style.

At block 920, the routine selects a character model for the NPC. This selection may involve identifying a base model from a library of pre-existing character models or constructing a new model based on the input data. For example, the system may select a tiger model to match the multimodal inputs related to the NPC's physical form. This model serves as the basis for further adaptation and refinement through subsequent processing stages.

At block 925, the routine adapts the generated visual data and behavior data to the selected target character model to generate an adapted configuration model. This adaptation process involves aligning the visual and behavioral characteristics with the target character model (e.g., mapping the Jack Sparrow-like behavior onto the tiger's skeletal structure). The adaptation ensures that both the appearance and actions of the NPC match the underlying character model and are cohesive with the NPC's persona.

At block 930, the routine generates rendering information for the NPC based on the adapted configuration model. This rendering information may include final textures, animations, and other graphical assets required for displaying the NPC within a virtual environment. The rendering information reflects the adapted NPC, combining both the visual appearance and behavior in accordance with the input characteristics. For example, the output may represent a tiger NPC that moves, gestures, and behaves in the style of Jack Sparrow, ready for display in a virtual world or simulation.

In some embodiments, the apparatus and techniques described above are implemented in a system including one or more integrated circuit (IC) devices (also referred to as integrated circuit packages or microchips), such as the language and image contextualization system described above. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving a multimodal plurality of inputs regarding characteristics of a non-player character (NPC) for a virtual environment;
processing the multimodal plurality of inputs to generate, in accordance with one or more of the characteristics, visual data representing an appearance of the NPC and behavior data representing one or more actions of the NPC;
adapting the generated visual data and the generated behavior data to a selected character model to generate an adapted configuration model in accordance with the characteristics; and
generating rendering information for the NPC based on the adapted configuration model.

2. The method of claim 1, wherein generating the behavior data comprises generating speech for the NPC in accordance with one or more of the characteristics.

3. The method of claim 1, further comprising selecting the character model based at least in part on the multimodal plurality of inputs and in accordance with one or more of the characteristics.

4. The method of claim 1, wherein processing the multimodal plurality of inputs comprises processing the multimodal plurality of inputs via a multimodal contextualizer to generate contextualized data representing two or more inputs of the multimodal plurality of inputs.

5. The method of claim 1, wherein to generate the visual data representing the appearance of the NPC comprises generating and applying to at least a portion of the selected character model one or more texture maps for the NPC, wherein the one or more texture maps comprises one or more of a group that includes a UV texture map, a diffuse texture map, a normals map, a roughness texture map, or a metallic texture map.

6. The method of claim 5, further comprising utilizing a text-to-image diffusion model to generate at least one of the one or more texture maps for the NPC.

7. The method of claim 1, wherein adapting the generated visual data and behavior data to the selected character model comprises transferring one or more aspects of a source character to the selected character model, the one or more aspects including one or more of a group that includes a pose of the source character, a structure of the source character, a movement of the source character, and a behavior of the source character.

8. The method of claim 1, wherein adapting the generated visual data and behavior data to the selected character model comprises refining at least some inputs of the multimodal plurality of inputs via a neural network implementing an iterative reverse diffusion processing stage on the at least some inputs.

9. The method of claim 1, wherein the multimodal plurality of inputs includes a persona input indicating a specific persona for the NPC, and wherein the generated behavior data is based at least in part on one or more actions corresponding to the persona input.

10. A system, comprising:
a memory;
one or more processors coupled to the memory, wherein in operation the one or more processors are to:
receive a multimodal plurality of inputs regarding characteristics of a non-player character (NPC) for a virtual environment;
process the multimodal plurality of inputs to generate, in accordance with one or more of the characteristics, visual data representing an appearance of the NPC and behavior data representing one or more actions of the NPC;
adapt the generated visual data and the generated behavior data to a selected character model to generate an adapted configuration model in accordance with the characteristics; and
generate rendering information for the NPC based on the adapted configuration model.

11. The system of claim 10, wherein to generate the behavior data comprises generating speech for the NPC in accordance with one or more of the characteristics.

12. The system of claim 10, wherein to process the multimodal plurality of inputs comprises processing the multimodal plurality of inputs via a multimodal contextualizer to generate contextualized data representing two or more inputs of the multimodal plurality of inputs.

13. The system of claim 10, wherein to generate the visual data representing the appearance of the NPC comprises generating and applying to at least a portion of the selected character model one or more texture maps for the NPC, wherein the one or more texture maps comprises one or more of a group that includes a UV texture map, a diffuse texture map, a normals map, a roughness texture map, or a metallic texture map.

14. The system of claim 13, wherein in operation the one or more processors are further to utilize a text-to-image diffusion model to generate at least one of the one or more texture maps for the NPC.

15. The system of claim 10, wherein to adapt the generated visual data and behavior data to the selected character model comprises transferring one or more aspects of a source character to the selected character model, the one or more aspects including one or more of a group that includes a pose of the source character, a structure of the source character, a movement of the source character, and a behavior of the source character.

16. The system of claim 10, wherein in operation the one or more processors are further to execute one or more neural networks, and wherein to adapt the generated visual data and behavior data to the selected character model comprises refining at least some inputs of the multimodal plurality of inputs via at least one of the one or more neural networks implementing one or more iterative reverse diffusion processing stages on the at least some inputs.

17. The system of claim 10, wherein the multimodal plurality of inputs includes a persona input indicating a specific persona for the NPC, and wherein the generated behavior data is based at least in part on one or more actions corresponding to the persona input.

18. A non-transitory computer-readable storage medium storing executable instructions that, when executed by one or more processors, configure the one or more processors to:
receive a multimodal plurality of inputs regarding characteristics of a non-player character (NPC) for a virtual environment;
process the multimodal plurality of inputs to generate, in accordance with the characteristics, visual data representing an appearance of the NPC and behavior data representing one or more actions of the NPC;
adapt the generated visual data and the generated behavior data to a selected character model to generate an adapted configuration model in accordance with the characteristics; and
generate rendering information for the NPC based on the adapted configuration model.

19. The non-transitory computer-readable storage medium of claim 18, wherein to adapt the generated visual data and behavior data to the selected character model comprises transferring one or more aspects of a source character to the selected character model, the one or more aspects including one or more of a group that includes a pose of the source character, a structure of the source character, a movement of the source character, and a behavior of the source character.

20. The non-transitory computer-readable storage medium of claim 18, wherein the executable instructions further configure the one or more processors to execute one or more neural networks, and wherein to adapt the generated visual data and behavior data to the selected character model comprises refining at least some inputs of the multimodal plurality of inputs via at least one of the one or more neural networks implementing an iterative reverse diffusion processing stage on the at least some inputs.
